(19) United States
(12) Patent Application Publication
(10) Pub. No.: US 2014/0236578 A1
(43) Pub. Date: Aug. 21, 2014

(54) Question-Answering by Recursive Parse Tree Descent

(71) Applicant: NEC Laboratories America, Inc., Princeton, NJ (US)

(72) Inventors: Christopher Malon, Fort Lee, NJ (US); Bing Bai, Princeton Junction, NJ (US)

(73) Assignee: NEC Laboratories America, Inc., Princeton, NJ (US)

(21) Appl. No.: 14/166,273

(22) Filed: Jan. 28, 2014

Related U.S. Application Data
(60) Provisional application No. 61/765,427, filed on Feb. 15, 2013.
(60) Provisional application No. 61/765,848, filed on Feb. 18, 2013.

(51) Int. Cl. G06F 17/28; G06N 3/02

(52) U.S. Cl. CPC G06F 17/28; G06N 3/02
USPC 704/9

(57) ABSTRACT

Systems and methods are disclosed to answer free form questions using recursive neural network (RNN) by defining feature representations at every node of a parse trees of questions and supporting sentences, when applied recursively, starting with token vectors from a neural probabilistic language model; and extracting answers to arbitrary natural language questions from supporting sentences.

This application is a utility conversion and claims priority to Provisional Application Serial No. 61/765,427 filed Feb. 15, 2013 and 61/765,848 filed Feb. 18, 2013, the contents of which are incorporated by reference.

### BACKGROUND

The present invention relates to question answering systems.

A computer cannot be said to have a complete knowledge representation of a sentence until it can answer all the questions a human can ask about that sentence.

Until recently, machine learning has played only a small part in natural language processing. Instead of improving statistical models, many systems achieved state-of-the-art performance with simple linear statistical models applied to features that were carefully constructed for individual tasks such as chunking, named entity recognition, and semantic role labeling.

Question-answering should require an approach with more generality than any syntactic-level task, partly because any syntactic task could be posed in the form of a natural language question, yet QA systems have again been focusing on feature development rather than learning general semantic feature representations and developing new classifiers.

The blame for the lack of progress on full-text natural language question-answering lies as much in a lack of appropriate data sets as in a lack of advanced algorithms in machine learning. Semantic-level tasks such as QA have been posed in a way that is intractable to machine learning classifiers alone without relying on a large pipeline of external modules, hand-crafted ontologies, and heuristics.

### SUMMARY

In one aspect, a method to answer free form questions using recursive neural network (RNN) includes defining feature representations at every node of a parse trees of questions and supporting sentences, when applied recursively, starting with token vectors from a neural probabilistic language model; and extracting answers to arbitrary natural language questions from supporting sentences.

In another aspect, systems and methods are disclosed for representing a word by extracting n-dimensions for the word from an original language model; if the word has been previously processed, use values previously chosen to define an (n+m) dimensional vector and otherwise randomly selecting m values to define the (n+m) dimensional vector; and applying the (n+m) dimensional vector to represent words that are not well-represented in the language model.

Implementation of the above aspects can include one or more of the following. The system takes a (question, support sentence) pair, parses both question and support, and selects a substring of the support sentence as the answer. The recursive neural network, co-trained on recognizing descendants, establishes are presentation for each node in both parse trees. A convolutional neural network classifies each node, starting from the root, based upon the representations of the node, its siblings, its parent, and the question. Following the positive classifications, the system selects a substring of the support as the answer. The system provides a top-down supervised method using continuous word features in parse trees to find the answer; and a co-training task for training a recursive neural network that preserves deep structural information.

We train and test our CNN on the Turk QA data set, a crowd sourced data set of natural language questions and answers of over 3,000 support sentences and 10,000 short answer questions.

Advantages of the system may include one or more of the following. Using meaning representations of the question and supporting sentences, our approach buys us freedom from explicit rules, question and answer types, and exact string matching. The system fixes neither the types of the questions nor the forms of the answers; and the system classifies tokens to match a substring chosen by the question's author.

### BRIEF DESCRIPTION OF THE DRAWINGS

FIG. 1 shows an exemplary neural probabilistic language model.

FIG. 2 shows an exemplary application of the language model to a rare word.

FIG. 3 shows an exemplary process for processing text using the model of FIG. 1.

FIG. 4 shows an exemplary rooted tree structure.

FIG. 5 shows an exemplary recursive neural network that includes an autoencoder and an auto decoder.

FIG. 6 shows an exemplary training process for recursive neural networks with sub tree recognition.

FIG. 7 shows an example of how the tree of FIG. 4 is populated with features.

FIG. 8 shows an example for the operation of the encoders and decoders.

FIG. 9 shows an exemplary computer to handle question answering tasks.

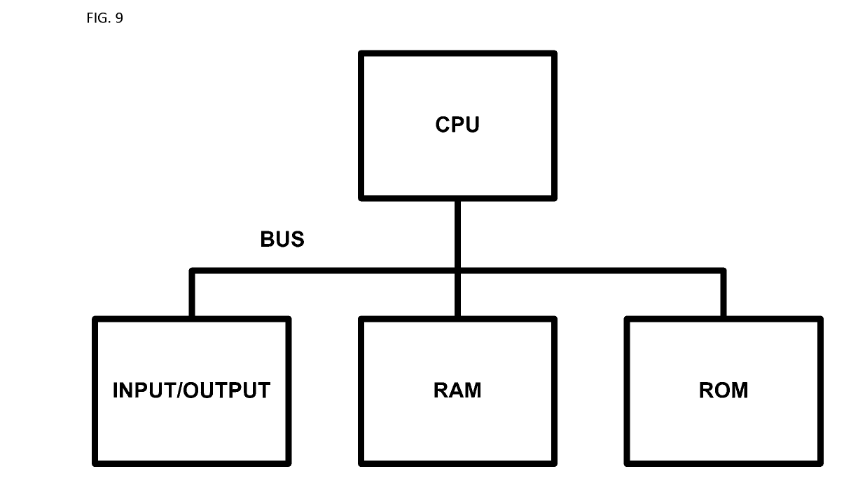

### DESCRIPTION

A recursive neural network (RNN) is discussed next that can extract answers to arbitrary natural language questions from supporting sentences, by training on a crowd sourced data set. The RNN defines feature representations at every node of the parse trees of questions and supporting sentences, when applied recursively, starting with token vectors from a neural probabilistic language model.

Our classifier decides to follow each parse tree node of a support sentence or not, by classifying its RNN embedding together with those of its siblings and the root node of the question, until reaching the tokens it selects as the answer. A co-training task for the RNN, on subtree recognition, boosts performance, along with a scheme to consistently handle words that are not well-represented in the language model. On our data set, we surpass an open source system epitomizing a classic “pattern bootstrapping” approach to question answering.

The classifier recursively classifies nodes of the parse tree of a supporting sentence. The positively classified nodes are followed down the tree, and any positively classified terminal nodes become the tokens in the answer. Feature representations are dense vectors in a continuous feature space; for the terminal nodes, they are the word vectors in a neural probabilistic language model, and for interior nodes, they are derived from children by recursive application of an autoencoder.

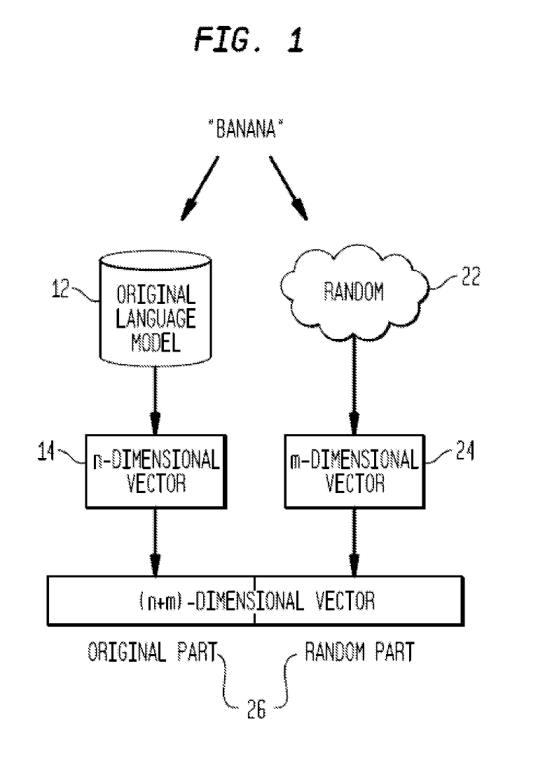

FIG. 1 shows an exemplary neural probabilistic language model. For illustration, supposed the original neural probabilistic language model has feature vectors for N words, each with dimension n. Let p be the vector to which the model assigns rare words (i.e. words that are not among the N words). We construct a new language model, in which each feature vector has dimension n+m (we recommend m=log n). For a word that is not rare (i.e. among the N words), let the first n dimensions of the feature vector match those in the original language model. Let the remaining m dimensions take random values. For a word that is rare, let the first n dimensions be those from the vector p. Let the remaining m dimensions take random values. Thus, in the resulting model, the first n dimensions always match the original model, but the remaining m can be used to distinguish or identify any word, including rare words. In FIG. 1 words are entered into an original language model database 12 which are fed to an n-dimensional vector 14. The same word is provided to a randomizer 22 that generates an m-dimensional vector 24. The result is an (n+m) dimensional vector 26 that includes the original part and the random part.

The system results in high quality. In the first applications of neural probabilistic language models, such as part-of-speech tagging, it was good enough to use the same symbol for any rare words. However, new applications, such as question-answering, force a neural information processing system to do matching based on the values of features in the language model. For these applications, it is essential to have a model that is useful for modeling the language (through the first part of the feature vector) but can also be used to match words (through the second part).

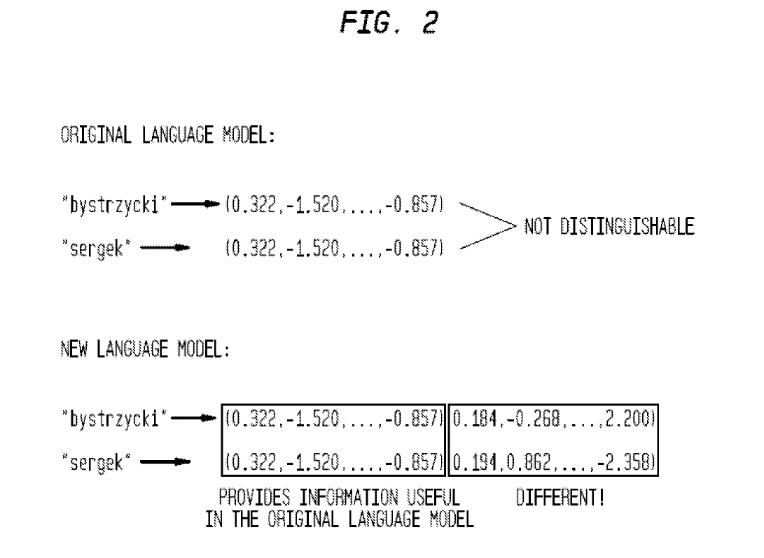

FIG. 2 shows an exemplary application of the language model of FIG. 1 to rare words and how the result can be distinguished by recognizers. In the example, using the original language model, the result is not distinguishable. Applying the new language model results in two parts, the first part provides information useful in the original language model, while the second part is different and can be used to distinguish the rare words.

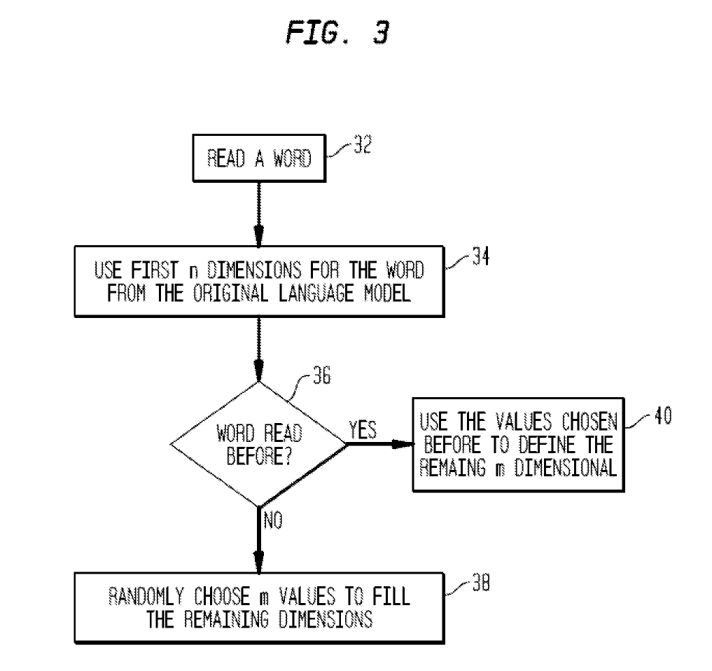

FIG. 3 shows an exemplary process for processing text using the model of FIG. 1. The process reads a word (32) and uses the first n dimensions for the word from the original language model (34). The process then checks if the word has been read before (36). If not, the process randomly chooses m values to fill the remaining dimensions (38). Otherwise, the process uses the previously selected value to define the remaining m dimensions (40).

The key is to concatenate the existing language model vectors with randomly chosen feature values. The choices must be the same each time the word is encountered while the system processes a text. There are many ways to make these random choices consistently. One is to fix M random vectors before processing, and maintain a memory while processing a text.

Each time a new word is encountered while reading a text, the word is added to the memory, with the assignment to one of the random vectors. Another way is to use a hash function, applied to the spelling of a word, to determine the values for each of the m dimensions. Then no memory of new word assignments is needed, because applying the hash function guarantees consistent choices.

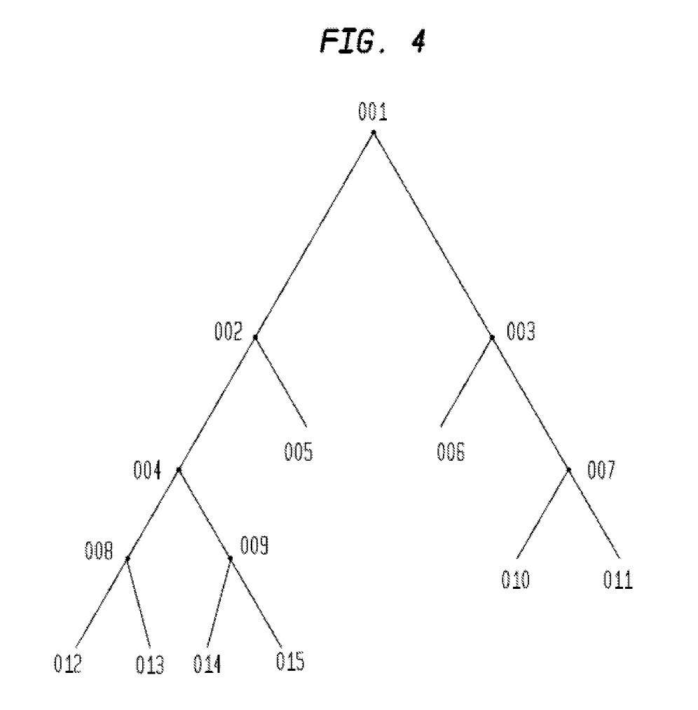

FIG. 4 shows an exemplary rooted tree structure. The structure of FIG. 4 is a rooted tree structure with feature vectors attached to terminal nodes. For the rooted tree structure, the system produces a feature vector at every internal node, including the root. In the example of FIG. 4, the tree is rooted at node 001. Node 002 is an ancestor of node 009, but is not an ancestor of node 010. Given features at the terminal nodes (005, 006, 010, 011, 012, 013, 014, and 015), the system produces features for all other nodes of the tree.

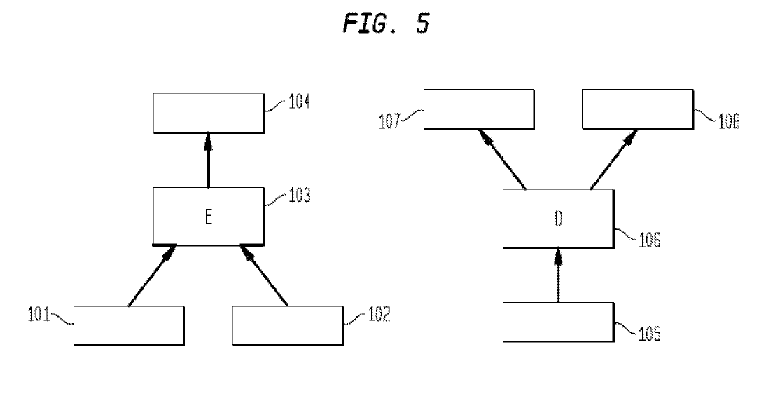

As shown in FIG. 5, the system uses a recursive neural network that includes an autoencoder 103 and an autodecoder 106, trained in combination with each other. The autoencoder 103 receives multiple vector inputs 101, 102 and produces a single output vector 104. Correspondingly, the autodecoder D 106 takes one input vector 105 and produces output vectors 107-108. A recursive network trained for reconstruction error would minimize the distance between 107 and 101 plus the distance between 108 and 102. At any level of the tree, the autoencoder combines feature vectors of child nodes into a feature vector for the parent node, and the autodecoder takes a representation of a parent node and attempts to reconstruct the representations of the child nodes. The autoencoder can provide features for every node in the tree, by applying itself recursively in a post order depth first traversal. Most previous recursive neural networks are trained to minimize reconstruction error, which is the distance between the reconstructed feature vectors and the originals.

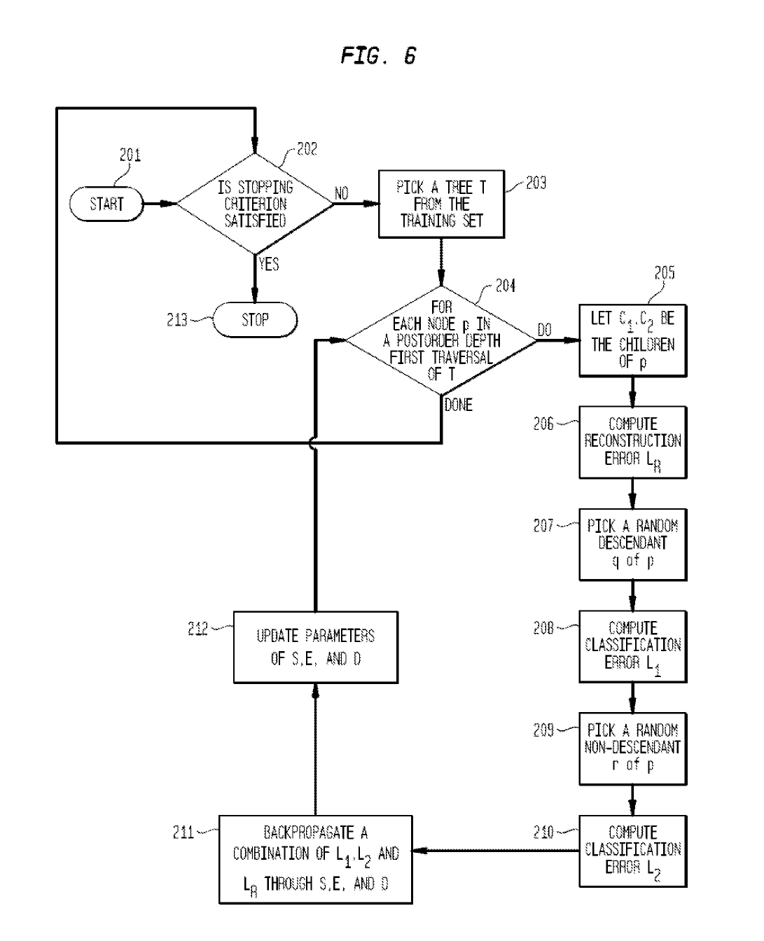

FIG. 6 shows an exemplary training process for recursive neural networks with subtree recognition. One embodiment uses stochastic gradient descent as described in more details below. Turning now to FIG. 6, from start 201, the process checks if a stopping criterion has been met (202). If so, the process exits (213) and otherwise the process picks a tree T from a training data set (203). Next, for each node p in a post-order depth first traversal of T (204), the process performs the following. First the process sets c1, c2 to be the children of p (205). Next, it determines a reconstruction error Lr (206). The process then picks a random descendant q of p (207) and determines classification error L1 (208). The process then picks a random non-descendant r of p (209), and again determines a classification error L2 (210). The process performs back propagation on a combination of L1, L2, and Lr through S, E, and D (211). The process updates parameters (212) and loops back to 204 until all nodes have been processed.

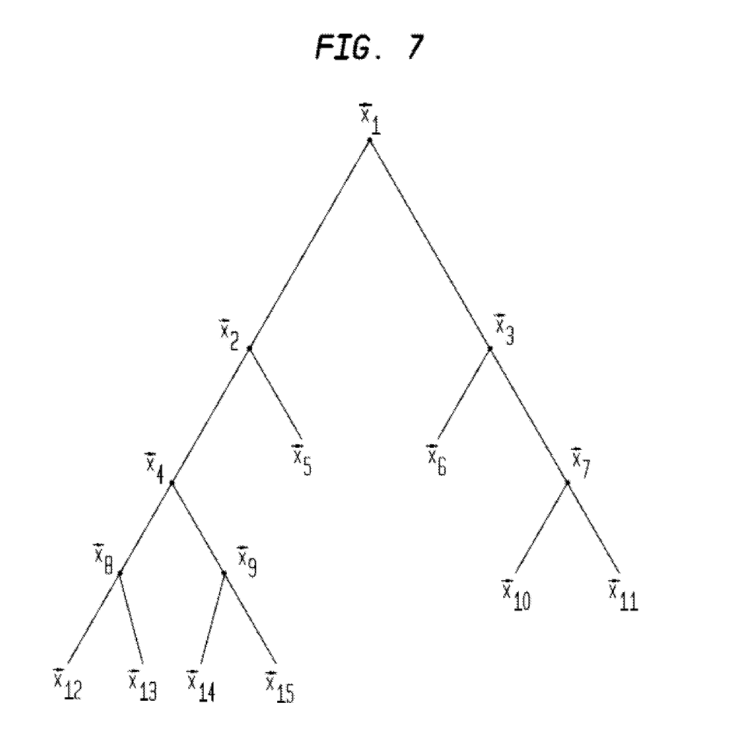

FIG. 7 shows an example of how the tree of FIG. 4 is populated with features at every node using the autoencoder E with features at terminal nodes X5, X6, and X10-X15. The process determines

| | |
|---|---|
| X8 = E (X12, X13) | X9 = E (X14, 15) |
| X4 = E (X8, X9) | X7 = E (X10, X11) |
| X2 = E (X4, X5) | X3 = E (X6, X7) |
| X1 = E (X2, X3) | |

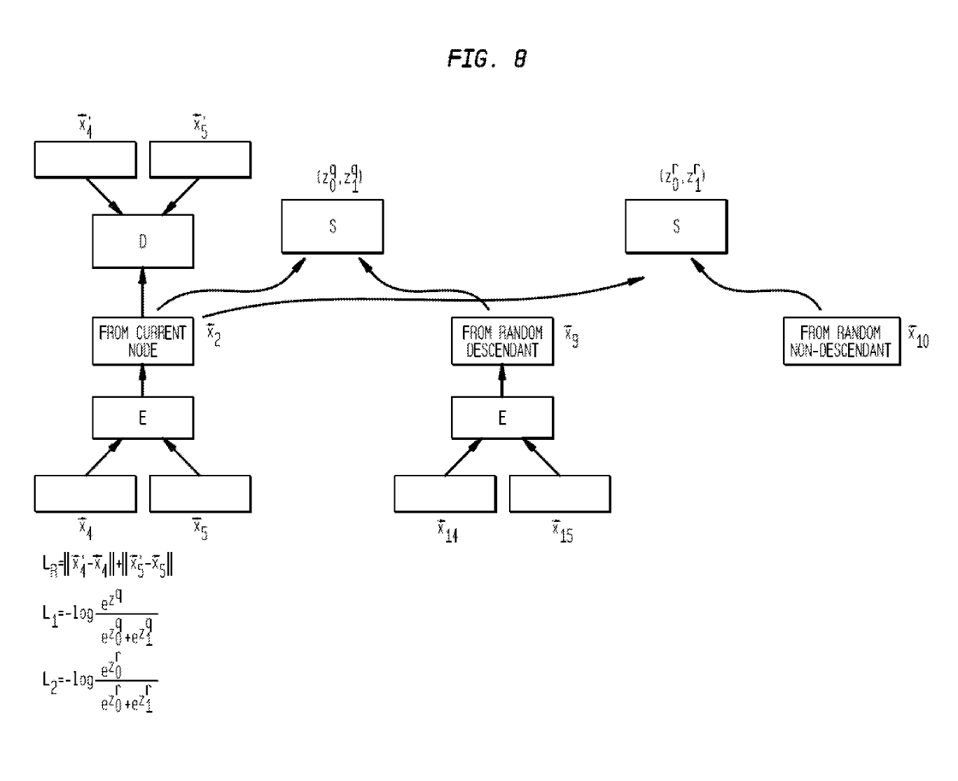

FIG. 8 shows an example for the operation of the encoders and decoders. In this example, the system determines classification and reconstruction errors of Algorithm 2. In this example, p is node 002 of FIG. 4, q is node 009 and r is node 010.

The system uses a recursive neural network to solve the problem, but adds an additional training objective, which is subtree recognition. In addition to the autoencoder E 103 and autodecoder D 106, the system includes a neural network, which we call the subtree classifier. The subtree classifier takes feature representations at any two nodes as input, and predicts whether the first node is an ancestor of the second. The autodecoder and subtree classifier both depend on the autoencoder, so they are trained together, to minimize a weighted sum of reconstruction error and subtree classification error. After training, the autodecoder and subtree classifier may be discarded; the autoencoder alone can be used to solve the language model.

The combination of recursive autoencoders with convolutions inside the tree affords flexibility and generality. The ordering of children would be immeasurable by a classifier relying on path-based features alone. For instance, our classifier may consider a branch of a parse tree as in FIG. 2, in which the birth date and death date have isomorphic connections to the rest of the parse tree. Unlike path-based features, which would treat the birth and death dates equivalently, the convolutions are sensitive to the ordering of the words.

Details of the recursive neural networks are discussed next. Autoencoders consist of two neural networks: an encoder E to compress multiple input vectors into a single output vector, and a decoder D to restore the inputs from the compressed vector. Through recursion, autoencoders allow single vectors to represent variable length data structures. Supposing each terminal node t of a rooted tree T has been assigned a feature vector \vec{x}(t)εRⁿ, the encoder E is used to define n-dimensional feature vectors at all remaining nodes. Assuming for simplicity that T is a binary tree, the encoder E takes the form E:Rⁿ×Rⁿ→Rⁿ. Given children c₁ and c₂ of a node p, the encoder assigns the representation \vec{x}(p)=E(\vec{x}(c₁),\vec{x}(c₂)). Applying this rule recursively defines vectors at every node of the tree.

The decoder and encoder may be trained together to minimize reconstruction error, typically Euclidean distance. Applied to a set of trees T with features already assigned at their terminal nodes, autoencoder training minimizes:

$${L}_{ae} = {\sum }_{t ∈ T} {\sum }_{p ∈ N ( t )} {\sum }_{{c}_{i} ∈ C ( p )} ‖ {x}^{′} ( {c}_{i} ) - x ( {c}_{i} ) ‖ , \qquad ( 1 )$$

where N(t) is the set of non-terminal nodes of tree t, C(p)=c₁,c₂ is the set of children of node p, and (\vec{x}′(c₁),(\vec{x}′(c₂))=D(E(\vec{x}(c₁),\vec{x}(c₂))). This loss can be trained with stochastic gradient descent [ ].

However, there have been some perennial concerns about autoencoders:

1. Is information lost after repeated recursion?

2. Does low reconstruction error actually keep the information needed for classification?

The system uses subtree recognition as a semi-supervised co-training task for any recurrent neural network on tree structures. This task can be defined just as generally as reconstruction error. While accepting that some information will be lost as we go up the tree, the co-training objective encourages the encoder to produce representations that can answer basic questions about the presence or absence of descendants far below.

Subtree recognition is a binary classification problem concerning two nodes x and y of a tree T; we train a neural network S to predict whether y is a descendant of x. The neural network S should produce two outputs, corresponding to log probabilities that the descendant relation is satisfied. In our experiments, we take S (as we do E and D) to have one hidden layer. We train the outputs S(x,y)=(z₀,z₁) to minimize the cross-entropy function

$$h ( ( {z}_{0} , {z}_{1} ) , j ) = - log ( \frac{{e}^{{z}_{j}}}{{e}^{{z}_{0}} + {e}^{{z}_{1}}} ) for j = 0 , 1. \qquad ( 2 )$$

so that z₀ and z₁ estimate log likelihoods that the descendant relation is satisfied.
Our algorithm for training the subtree classifier is discussed next. One implementation uses SENNA software, which is used to compute parse trees for sentences. Training on a corpus of 64,421 Wikipedia sentences and testing on 20,160, we achieve a test error rate of 3.2% on pairs of parse tree nodes that are subtrees, for 6.9% on pairs that are not subtrees (F1=0.95), with 0.02 mean squared reconstruction error.

Application of the recursive neural network begins with features from the terminal nodes (the tokens). These features come from the language model of SENNA, the Semantic Extraction Neural Network Architecture. Originally, neural probabilistic language models associated words with learned feature vectors so that a neural network could predict the joint probability function of word sequences. SENNA's language model is co-trained on many syntactic tagging tasks, with a semi-supervised task in which valid sentences are to be ranked above sentences with random word replacements. Through the ranking and tagging tasks, this model learned embeddings of each word in a 50-dimensional space. Besides this learned representations, we encode capitalization and SENNA's predictions of named entity and part of speech tags with random vectors associated to each possible tag, as shown in FIG. 1. The dimensionality of these vectors is chosen roughly as the logarithm of the number of possible tags. Thus every terminal node obtains a 61-dimensional feature vector.

We modify the basic RNN construction of Section 4 to obtain features for interior nodes. Since interior tree nodes are tagged with a node type, we encode the possible node types in a six-dimensional vector and make E and D work on triples (Parent Type, Child 1, Child 2), instead of pairs (Child 1, Child 2). The recursive autoencoder then assigns features to nodes of the parse tree of, for example, “The cat sat on the mat.” Note that the node types (e.g. “NP” or “VP”) of internal nodes, and not just the children, are encoded.

Also, parse trees are not necessarily binary, so we binarize by right-factoring. Newly created internal nodes are labeled as “SPLIT” nodes. For example, a node with children c₁,c₂,c₃ is replaced by a new node with the same label, with left child c₁ and newly created right child, labeled “SPLIT,” with children c₂ and c₃.

Vectors from terminal nodes are padded with 200 zeros before they are input to the autoencoder. We do this so that interior parse tree nodes have more room to encode the information about their children, as the original 61 dimensions may already be filled with information about just one word.

The feature construction is identical for the question and the support sentence.

Many QA systems derive powerful features from exact word matches. In our approach, we trust that the classifier will be able to match information from autoencoder features of related parse tree branches, if it needs to. But our neural language probabilistic language model is at a great disadvantage if its features cannot characterize words outside its original training set.

Since Wikipedia is an encyclopedia, it is common for support sentences to introduce entities that do not appear in the dictionary of 100,000 most common words for which our language model has learned features. In the support sentence:

Jean-Bedel Georges Bokassa, Crown Prince of Central Africa was born on the 2 Nov. 1975 the son of Emperor Bokassa I of the Central African Empire and his wife Catherine Denguiade, who became Empress on Bokassa's accession to the throne.

In the above example, both Bokassa and Denguiade are uncommon, and do not have learned language model embeddings. SENNA typically replaces these words with a fixed vector associated with all unknown words, and this works fine for syntactic tagging; the classifier learns to use the context around the unknown word. However, in a question-answering setting, we may need to read Denguiade from a question and be able to match it with Denguiade, not Bokassa, in the support.

The present system extends the language model vectors with a random vector associated to each distinct word. The random vectors are fixed for all the words in the original language model, but a new one is generated the first time any unknown word is read. For known words, the original 50 dimensions give useful syntactic and semantic information. For unknown words, the newly introduced dimensions facilitate word matching without disrupting predictions based on the original 50.

Next, the process for training the convolutional neural network for question answering is detailed. We extract answers from support sentences by classifying each token as a word to be included in the answer or not. Essentially, this decision is a tagging problem on the support sentence, with additional features required from the question.

Convolutional neural networks efficiently classify sequential (or multi-dimensional) data, with the ability to reuse computations within a sliding frame tracking the item to be classified. Convolving over token sequences has achieved state-of-the-art performance in part-of-speech tagging, named entity recognition, and chunking, and competitive performance in semantic role labeling and parsing, using one basic architecture. Moreover, at classification time, the approach is 200 times faster at POS tagging than next-best systems.

Classifying tokens to answer questions involves not only information from nearby tokens, but long range syntactic dependencies. In most work utilizing parse trees as input, a systematic description of the whole parse tree has not been used. Some state-of-the-art semantic role labeling systems require multiple parse trees (alternative candidates for parsing the same sentence) as input, but they measure many ad-hoc features describing path lengths, head words of prepositional phrases, clause-based path features, etc., encoded in a sparse feature vector.

By using feature representations from our RNN and performing convolutions across siblings inside the tree, instead of token sequences in the text, we can utilize the parse tree information in a more principled way. We start at the root of the parse tree and select branches to follow, working down. At each step, the entire question is visible, via the representation at its root, and we decide whether or not to follow each branch of the support sentence. Ideally, irrelevant information will be cut at the point where syntactic information indicates it is no longer needed. The point at which we reach a terminal node may be too late to cut out the corresponding word; the context that indicates it is the wrong answer may have been visible only at a higher level in the parse tree. The classifier must cut words out earlier, though we do not specify exactly where.

Our classifier uses three pieces of information to decide whether to follow a node in the support sentence or not, given that its parent was followed:

1. The representation of the question at its root

2. The representation of the support sentence at the parent of the current node

3. The representations of the current node and a frame of k of its siblings on each side, in the order induced by the order of words in the sentence

Each of these representations is n-dimensional. The convolutional neural network concatenates them together (denoted by ⊕) as a 3n-dimensional feature at each node position, and considers a frame enclosing k siblings on each side of the current node. The CNN consists of a convolutional layer mapping the 3n inputs to an r-dimensional space, a sigmoid function (such as tan h), a linear layer mapping the r-dimensional space to two outputs, and another sigmoid. We take k=2 and r=30 in the experiments.

Application of the CNN begins with the children of the root, and proceeds in breadth first order through the children of the followed nodes. Sliding the CNN's frame across siblings allows it to decide whether to follow adjacent siblings faster than a non-convolutional classifier, where the decisions would be computed without exploiting the overlapping features. A followed terminal node becomes part of the short answer of the system.

The training of the question-answering convolutional neural network is discussed next. Only visited nodes, as predicted by the classifier, are used for training. For ground truth, we say that a node should be followed if it is the ancestor of some token that is part of the desired answer. Exemplary processes for the neural network are disclosed below:

ALGORITHM 1
Classical auto-encoder training by stochastic gradient descent

```
Data: E : [symbol]     × [symbol]     → [symbol]    a neutral network (encoder)
Data: D : [symbol]     → [symbol]     × [symbol]    a neural network (decoder)
Data: [symbol]     a set of trees [symbol]     with features \vec{x}(t) assigned to terminal nodes t ε [symbol]
Result: Weights of E and D trained to minimize reconstruction error
begin
  while stopping criterion not satisfied do
    Randomly choose T ε [symbol]
    for p in a postorder depth first traversal of T do
      if p is not terminal then
        Let c₁, c₂ be the children of p
        Compute \vec{x}(p) = E(\vec{x}(c₁), \vec{x}(c₂))
        Let (\vec{x}(c₁), \vec{x}(c₂)) = D(\vec{x}(p))
        Compute loss L = ∥\vec{x}′(c₁) − \vec{x}(c₁)∥₂ + ∥\vec{x}′(c₂) − \vec{x}(c₂)∥₂
        Compute gradients of loss with respect to parameters of D and E
        Update parameters of D and E by backpropagation
      end
    end
  end
end
```

ALGORITHM 2
Auto-encoders co-trained for subtree recognition by stochastic gradient descent

```
Data: E : [symbol]     × [symbol]     → [symbol]     a neural network (encoder)
Data: S : [symbol]     × [symbol]     → [symbol]     a neural network for binary classification (subtree or not)
Data: D : [symbol]     → [symbol]     × [symbol]     a neural network (decoder)
Data: [symbol]     a set of trees T with features \vec{x}(t) assigned to terminal nodes t ε T
Result: Weights of E and D trained to minimize a combination of reconstruction and subtree
    recognition error
begin
  while stopping criterion not satisfied do
    Randomly choose T ε [symbol]
    for p in a postorder depth first traversal of T do
      if p is not terminal then
        Let c₁, c₂ be the children of p
        Compute \vec{x}(p) = E(\vec{x}(c₁), \vec{x}(c₂))
        Let (\vec{x}′(c₁),(\vec{x}′(c₂)) = D(\vec{x}(p))
        Compute reconstruction loss L_{R} = ∥\vec{x}′(c₁) − \vec{x}(c₁)∥₂ + ∥\vec{x}′(c₂) − \vec{x}(c₂)∥₂
        Compute gradients of L_{R} with respect to parameters of D and E
        Update parameters of D and E by backpropagation
        Choose a random q ε T such that q is a descendant of p
        Let c₁^{q}, c₂^{q} be the children of q, if they exist
        Compute S(\vec{x}(p), \vec{x}(q)) = S(E(\vec{x}(c₁), \vec{x}(c₂)), E(\vec{x}(c₁^{q}), \vec{x}(c₂^{q})))
        Compute cross-entropy loss L₁ = h(S(\vec{x}(p), \vec{x}(q)),1)
        Compute gradients of L₁ with respect to weights of S and E, fixing
        \vec{x}(c₁),\vec{x}(c₂), \vec{x}(c₁^{q}), \vec{x}(c₂^{q})
        Update parameters of S and E by backpropagation
        if p is not the root of T then
          Choose a random r ε T such that r is not a descendant of p
          Let c₁^{r}, c₂^{r} be the children of r, if they exist
          Compute cross-entropy loss L₂ = h(S(\vec{x}(p), \vec{x}(r)),0)
          Compute gradients of L₂ with respect to weights of S and E, fixing
          \vec{x}(c₁), \vec{x}(c₂), \vec{x}(c₁^{r}), \vec{x}(c₂^{r})
          Update parameters of S and E by backpropagation
        end
      end
    end
  end
end
```

ALGORITHM 3
Applying the convolutional neural network for question answering

```
Data: (Q, S), parse trees of a question and support sentence,
with parse tree features
Data: \vec{x}(p) attached by the recursive autoencoder for all p ε Q or p ε S
Let n = dim \vec{x}(p)
Let h be the cross-entropy loss (equation (1))
Data: Φ [symbol]     → [symbol]     a convolutional neural network
trained for question-answering as in
    Algorithm 4
Result: A ⊂ W(S), a possibly empty subset of the words of S
begin
  Let q = root(Q)
  Let r = root(S)
  Let X = {r}
  Let A =
  while X ≠ do
    Pop an element p from X
    if p is terminal then
      Let A = A∪ {w(p)}, the word corresponding to p
    else
      Let c₁,...,cₘ be the children of p
      Let \vec{x}ⱼ = \vec{x}(cⱼ) for j ε {1,...,m}
      Let \vec{x}ⱼ = \vec{0} for j ∉ {1,...,m}
      for i=1,...m do
        if h (Φ ( [symbol]   ⱼ₌ᵢ₋ₖ ^{i+k} (\vec{x}(q) [symbol]   \vec{x}(p) [symbol]   \vec{x}ⱼ)),1)
< − log ½ then
          Let X = X ∪ [cᵢ}
        end
      end
    end
  end
  Output the set of words in A
end
```

ALGORITHM 4
Training the convolutional neural network for question answering

```
Data: Ξ, a set of triples (Q, S, T), with Q a parse tree of a question, S a parse tree of a support
    sentence, and T ⊂ W(S) a ground truth answer substring, and parse tree features \vec{x}(p)
    attached by the recursive autoencoder for all p ∈ Q or p ∈ S
Let n = dim \vec{x}(p)
Let h be the cross-entropy loss (equation (1))
Data: Φ : [symbol]     → [symbol]     a convolutional neural network over frames of size 2k + 1, with
    parameters to be trained for question-answering
Result: Parameters of Φ trained
begin
  while stopping criterion not satisfied do
    Randomly choose (Q, S, T) ∈ Ξ
    Let q = root(Q)
    Let r = root(S)
    Let X = {r}
    Let A(T) ⊂ S be the set of ancestors nodes of T in S
    while X ≠ do
      Pop an element p from X
      if p is not terminal then
        Let c₁, . . . , cₘ be the children of p
        Let \vec{x}ⱼ = \vec{x}(cⱼ) for j ∈ {1, . . . , m}
        Let \vec{x}ⱼ = \vec{0} for j ∉ {1, . . . , m}
        for i=l, . . . m do
          Let t = 1 if cᵢ ∈ A(T), or 0 otherwise
          Compute the cross-entropy loss h (Φ( [symbol]   ⱼ₌₁₋ₖ^{i+k} (\vec{x}(q) [symbol]     \vec{x}(p) [symbol]     \vec{x}ⱼ)),t)
          if h (Φ ( [symbol]   ⱼ₌₁₋ₖ^{i+k} (\vec{x}(q) [symbol]     \vec{x}(p) [symbol]     \vec{x}ⱼ)),1) < − log ½ then
            Let X = X ∪ {cᵢ}
          end
          Update parameters of Φ by backpropagation
        end
      end
    end
  end
end
```

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to answer free form questions using recursive neural network (RNN), comprising:
defining feature representations at every node of a parse trees of questions and supporting sentences, when applied recursively, starting with token vectors from a neural probabilistic language model; and
extracting answers to arbitrary natural language questions from supporting sentences.

2. The method of claim 1, comprising training on a crowd sourced data set.

3. The method of claim 1, comprising recursively classifying nodes of the parse tree of a supporting sentence.

4. The method of claim 1, comprising using learned representations of words and syntax in a parse tree structure to answer free form questions about natural language text.

5. The method of claim 1, comprising deciding to follow each parse tree node of a support sentence by classifying its RNN embedding together with those of siblings and a root node of the question, until reaching the tokens selected as the answer.

6. The method of claim 1, comprising performing a co-training task for the RNN, on subtree recognition.

7. The method of claim 6, wherein the co-training task for training the RNN preserves structural information.

8. The method of claim 1, wherein positively classified nodes are followed down the tree, and any positively classified terminal nodes become the tokens in the answer.

9. The method of claim 1, wherein feature representations are dense vectors in a continuous feature space and for the terminal nodes, the dense vectors comprise word vectors in a neural probabilistic language model, and for interior nodes, the dense vectors are derived from children by recursive application of an autoencoder.

10. The method of claim 1, comprising training outputs S(x,y)=(z₀,z₁) to minimize the cross-entropy function
$$h ( ( {z}_{0} , {z}_{1} ) , j ) = - log ( \frac{{e}^{{z}_{j}}}{{e}^{{z}_{0}} + {e}^{{z}_{1}}} ) for j = 0 , 1.$$
so that z₀ and z₁ estimate log likelihoods and a descendant relation is satisfied.

11. A method for representing a word, comprising:
extracting n-dimensions for the word from an original language model; and
if the word has been previously processed, use values previously chosen to define an (n+m) dimensional vector and otherwise randomly selecting m values to define the (n+m) dimensional vector.

12. The method of claim 11, comprising applying the n-dimensional language vector for syntactic tagging tasks.

13. The method of claim 11, comprising deciding to follow each parse tree node of a support sentence by classifying its RNN embedding together with those of siblings and a root node of the question, until reaching the tokens selected as the answer.

14. The method of claim 11, comprising training outputs S(x,y)=(z₀,z₁) to minimize the cross-entropy function
$$h ( ( {z}_{0} , {z}_{1} ) , j ) = - log ( \frac{{e}^{{z}_{j}}}{{e}^{{z}_{0}} + {e}^{{z}_{1}}} ) for j = 0 , 1.$$
so that z₀ and z₁ estimate log likelihoods and a descendant relation is satisfied.

15. A system, comprising
a processor to run a recursive neural network (RNN) to answer free form questions;
computer code for defining feature representations at every node of a parse trees of questions and supporting sentences, when applied recursively, starting with token vectors from a neural probabilistic language model; and
computer code for extracting answers to arbitrary natural language questions from supporting sentences.

16. The system of claim 15, comprising computer code for training on a crowd sourced data set.

17. The system of claim 15, comprising computer code for recursively classifying nodes of the parse tree of a supporting sentence.

18. The system of claim 15, comprising computer code for using learned representations of words and syntax in a parse tree structure to answer free form questions about natural language text

19. The system of claim 15, comprising computer code for deciding to follow each parse tree node of a support sentence by classifying its RNN embedding together with those of siblings and a root node of the question, until reaching the tokens selected as the answer.

20. The system of claim 1, wherein positively classified nodes are followed down the tree, and any positively classified terminal nodes become the tokens in the answer.
